(19) United States
(12) Patent Application Publication
(10) Pub. No.: US 2008/0107209 A1
(43) Pub. Date: May 8, 2008

(54) Slicer circuit capable of judging input signal correctly

(76) Inventors: Yu Cheng, Hsichu City (TW); Yi-Kuan Chen, Taipei City (TW); Chun-Wah Fan, Hong Kong (HK)

Correspondence Address: J.C. Patents;Suite 250, 4 Venture, Irvine, CA, 92618, US

(21) Appl. No.: 11/592,596

(22) Filed: Nov. 3, 2006

(51) Int. Cl. H04L 25/06; H04L 25/10

(52) U.S. Cl. 375/319

(57) ABSTRACT

A slicer circuit is disclosed. The slicer circuit has the feature that a counting-circuit is employed to count the number of continuous times of signals in a same level continuous outputted from the comparator thereof, and when the number of continuous times reaches a preset value, a control signal is output to make a resistance circuit consisting of dynamic devices open, so as to largely delay the up-shift or down-shift speed of an input DC reference level and enable the slicer circuit to continue to judge the input signal correctly according to the input DC reference level.

### BACKGROUND OF THE INVENTION

1. Field of Invention

The present invention relates to a slicer circuit, and more particularly, to a slicer circuit employing a counting-circuit.

2. Description of the Related Art

In a mobile communication system (MCS), a data slicer counts as a part of a data-recovery circuit to convert an analog data signal into a digital data signal. The signal input manner of a slicer circuit is mainly categorized into two kinds: input of single-ended modulation signal and input of dual-ended differential-mode modulation signal.

FIG. 1 is a schematic drawing of a conventional slicer circuit for inputting single modulation signals. The slicer circuit of FIG. 1 includes a comparator 102, a resistor 104 and a capacitor 106. Wherein, an input terminal of the comparator 102 is coupled with a modulation signal ip, while another input terminal is coupled with the modulation signal ip via the resistor 104. The capacitor 106 is used to make the node coupling the comparator 102 with the resistor 104 grounded, so as to make another input terminal of the comparator virtually coupled with a reference voltage Vref (not shown in the figure). When ip is larger than Vref, the comparator 102 outputs a digital signal in logic 1, otherwise, outputs a digital signal in logic 0.

FIG. 2 is a schematic drawing of a conventional slicer circuit for inputting differential-mode modulation signals. Referring to FIG. 2, the circuit includes a comparator 202, a resistor 204 and a capacitor 206. Wherein, an input terminal of the comparator 202 receives a modulation signal ip, while another input terminal receives a modulation signal in via the capacitor 206. The modulation signals ip and in are differential-mode signals in respect of each other.

Prior to sending the modulation signal in to the comparator 202, the modulation signal in would pass through a filter formed by the resistor 204 and the capacitor 206 to be converted into a modulation signal in′, and then the comparator 202 compares the modulation signal ip with the modulation signal in′. When the amplitude of ip is larger than the amplitude of in′, the comparator 202 would output a digital signal in logic 1, otherwise, output a digital signal in logic 0. However, as shown by FIGS. 3 and 4 (Compin represents a measured signal at the node where the resistor 204 is coupled with the modulation signal ip, Rxdata represents a measured output signal from the comparator 202 and Clock represents a clock signal), when the input signal contains a data stream in long “0” sequence or a data stream in long “1” sequence, the filter would affect the direct current (DC) level of the signal difference ip-in′ over a duty cycle where the resistor 204 and the capacitor 206 together perform a charge and a discharge. Consequently, the duty ratio of the digital output varies larger or smaller, which further influences the post-stage digital signal processing (DSP), produces error bits and results in errors of judging signals.

FIG. 5 is a schematic drawing of a conventional slicer circuit, which is a slicer circuit suitable for inputting a single modulation signal disclosed by Japan Matsushita Electric Industrial Co., Ltd. in the Japan patent application No. JP0010136030. The circuit includes a comparator 502, a control circuit 504, a post-stage switch set 506, a time constant circuit 508 and a pre-stage switch set 510. Wherein, the post-stage switch set 506 includes switches 520, 522 and 524. The time constant circuit 508 includes capacitors 526, 528 and 530 and resistors 532, 534 and 536. The pre-stage switch set 510 includes switches 538, 540 and 542.

A terminal of the switch set 510 receives a wireless recovery signal WRS, while another input terminal set thereof is coupled with the inputs of the time constant circuit 508. The outputs of the time constant circuit 508 are coupled with an input terminal set of the post-stage switch set 506. Another terminal of the post-stage switch set 506 is coupled with the negative input terminal of the comparator 502. The positive input terminal of the comparator 502 is coupled with the wireless recovery signal WRS and the comparator 502 outputs a baseband signal BS to the control circuit 504, which outputs a control signal CS1 and a control signal CS2 according to the baseband signal BS to respectively control the post-stage switch set 506 and the pre-stage switch set 510 for selecting an appropriate time constant. Although the duty ratio of the baseband signal BS in the circuit is nearly 50%, due to only a modulation signal input for the circuit, the circuit still suffers by noise interference.

### SUMMARY OF THE INVENTION

An objective of the present invention is to provide a slicer circuit capable of judging an input signal without making mistakes when the input signal contains a data stream in long “0” sequence or a data stream in long “1” sequence.

Another objective of the present invention is to provide a slicer circuit, wherein the differential-mode input signal of the comparator thereof is able to remain a certain level and does not continuously ascend or descend in exponential order therewith in response to an input signal containing a data stream in long “0” sequence or a data stream in long “1” sequence.

To achieve the aforementioned or other objectives, the present invention provides a slicer circuit which has the feature that a counting-circuit is employed to count the number continuous times of signals in a same level continuous outputted from the comparator thereof, and the number of continuous times reaches a preset value, a control signal is output to make a resistance circuit consisting of dynamic devices open, so as to largely delay the up-shift or down-shift speed of the differential-mode signal of the comparator and enable the slicer circuit to judge input signals correctly.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic drawing of a conventional slicer circuit for inputting a single modulation signal.

FIG. 2 is a schematic drawing of a conventional slicer circuit for inputting differential-mode modulation signals.

FIG. 3 illustrates a measured ip-in′ signal at the coupling node and a measured output signal from the comparator in a conventional slicer circuit for inputting a differential-mode modulation signal after the comparator receives a continuous logic 0 signal.

FIG. 4 illustrates a measured ip-in′ signal at the coupling node and a measured output signal from the comparator in a conventional slicer circuit for inputting a differential-mode modulation signal after the comparator receives a continuous logic 1 signal.

FIG. 5 is a schematic drawing of a conventional slicer circuit.

FIG. 6 is a schematic drawing of a slicer circuit according to an embodiment of the present invention.

FIG. 7 is a schematic drawing of a counting-circuit according to an embodiment of the present invention.

FIG. 8 illustrates a measured ip-in′ signal at the coupling node and a measured output signal from the comparator in a slicer circuit for inputting a differential-mode modulation signal after the comparator receives a continuous logic 0 signal according to an embodiment of the present invention.

FIG. 9 illustrates a measured ip-in′ signal at the coupling node and a measured output signal from the comparator in a slicer circuit for inputting a differential-mode modulation signal after the comparator receives a continuous logic 1 signal according to an embodiment of the present invention.

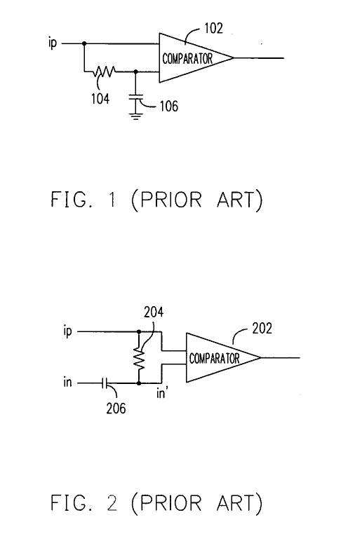

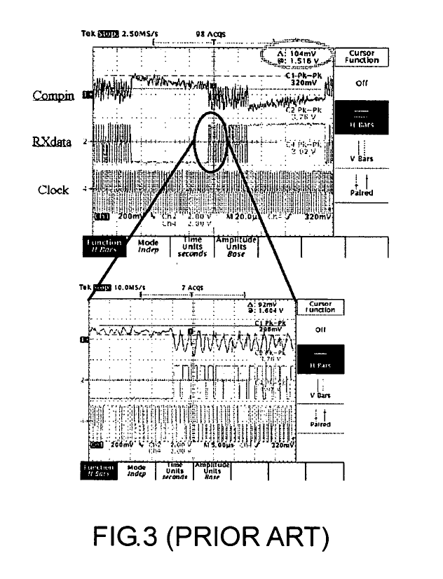

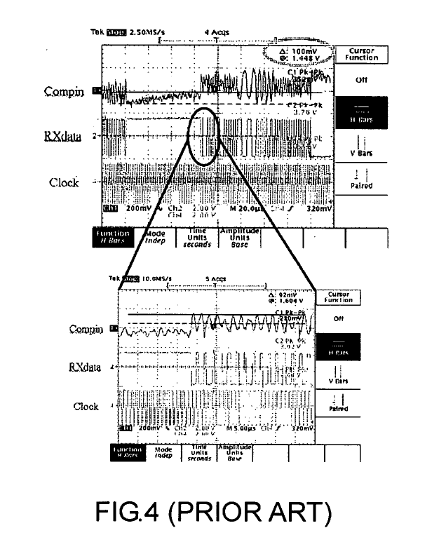

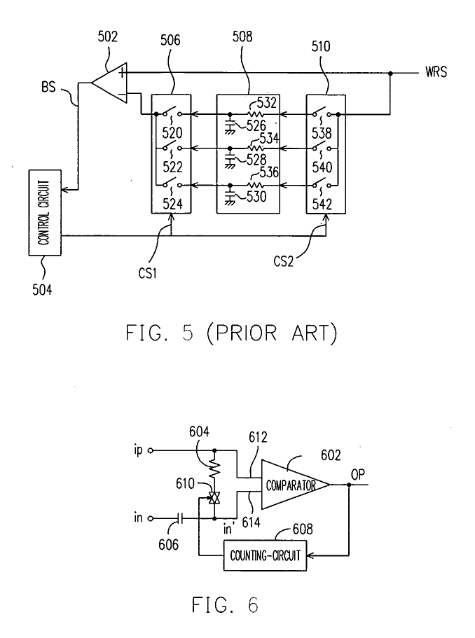

### DESCRIPTION OF THE EMBODIMENTS

FIG. 6 is a schematic drawing of a slicer circuit according to an embodiment of the present invention. Referring to FIG. 6, the slicer circuit includes a comparator 602, a resistor 604, a capacitor 606, a counting-circuit 608 and a switch 610. Wherein, an end of the resistor 604 is coupled with the first input terminal 612 of the comparator 602 and a first modulation signal ip, while another end of the resistor 604 is coupled with the second input terminal 614 of the comparator 602 via the switch 610. The second input terminal 614 of the comparator 602 is coupled with a second modulation signal in via the capacitor 606 and the output OP of the comparator 602 is coupled with the input of the counting-circuit 608. The resistor 604 and the switch 610 can be formed by an MOS (metal oxide semiconductor) active device at least, respectively. In the embodiment, the output of the counting-circuit 608 is coupled with the switch 610.

The first modulation signal ip and the second modulation signal in are filtered by a filter comprising the resistor 604 and the capacitor 606, and the second modulation signal in would be filtered first by the filter to converted into in′, followed by comparing the first modulation signal ip with the modulation signal in′ by the comparator 602. When the amplitude of ip is larger than the amplitude of in′, the comparator 602 would produce an output data in logic 1; otherwise, the comparator 602 would produce an output data in logic 0.

After the comparator 602 sequentially outputs the first output data and the second output data, the counting-circuit 608 starts to count the first output data in a same logic and the second output data in a same logic. When an output data contains continuous logic 0 bits or continuous logic 1 bits and when the number of the continuous times reaches a preset value of the counting-circuit, the counting-circuit 608 produces a control signal sent to the switch 610 to turn off the switch 610, so as to make the resistor 604 open. Thus, the time constant of charging-discharging performed by the resistor 604 and the capacitor 606 inclines to infinity, which makes the differential-mode input signal of the comparator 602 remain at a fixed voltage without an exponential decay any more.

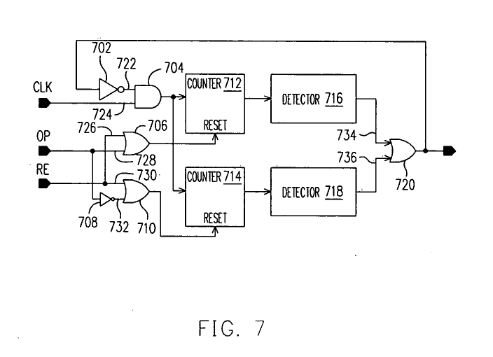

FIG. 7 is a schematic drawing of a counting-circuit according to an embodiment of the present invention. Referring to FIGS. 6 and 7, the counting-circuit 608 can include a first NOT gate 702, a second NOT gate 708, a first AND gate 704, a first OR gate 706, a second OR gate 710, a first counter 712, a second counter 714, a first detector 716, a second detector 718 and a third OR gate 720.

The input terminal of the first NOT gate 702 is coupled with the output of the entire counting-circuit 608 (i.e. the output of the third OR gate 720), the output terminal thereof is coupled with the first input terminal 722 of the first AND gate 704. The second input terminal 724 of first AND gate 704 receives a clock signal CLK. The first input terminal 726 of the first OR gate 706 receives a reset signal RE, while the second input terminal 728 thereof is coupled with the output OP of the comparator 602. The input terminal of the second NOT gate 708 is coupled with the output OP of the comparator 602. The first input terminal 730 of the second OR gate 710 receives the reset signal RE, while the second input terminal 732 thereof is coupled with the output of the second NOT gate 708. The input terminal of the first counter 712 is coupled with the output of the first AND gate 704, while the reset terminal thereof is coupled with the output of the first OR gate 706. The input terminal of the second counter 714 is coupled with the output of the first AND gate 704, while the reset terminal thereof is coupled with the output of the second OR gate 710. The input terminal of the first detector 716 is coupled with the output of the first counter 712, while the output terminal thereof is coupled with the first input terminal 734 of the third OR gate 720. The input terminal of the second detector 718 is coupled with the output of the second counter 714, while the output terminal thereof is coupled with the second input terminal 736 of the third OR gate 720.

The output of the entire counting-circuit 608 (i.e. the output of the third OR gate 720) is phase-inverted by the first NOT gate 702, which is afterwards sent to the first AND gate 704 where a logic operation is performed on the phase-inverted output and the clock signal CLK. When the output of the counting-circuit 608 is logic 0 and the clock signal CLK is logic 1, the first AND gate 704 would output logic 1, so as to make the counters 712 and 714 start to count. When the clock signal CLK is logic 0 or the output of the counting-circuit 608 is logic 1 and the clock signal CLK is logic 1, the first AND gate 704 would output logic 0 and the counters 712 and 714 at the point do not count.

When the status of the reset signal RE is logic 0 and the output OP of the comparator 602 is logic 0 as well, the output OP would be phase-inverted by the second NOT gate 708, which is afterwards sent to the second OR gate 710 where a logic operation is performed on the phase-inverted output and the reset signal RE. Finally, the second OR gate 710 outputs logic 1 to reset the counting value of the counter 714, so as to make the output of the detector 718 be logic 0. The output OP of the comparator 602 is sent to the first OR gate 706 where a logic operation on the output OP and the reset signal RE is performed, and then the first OR gate 706 outputs logic 0 to make the counter 712 continue to count and the counting value is sent to the detector 716 for judging.

If the output status of the comparator 602 is continuous logic 0, the counter 714 would be reset all the time, while the counter 712 would keep counting and keep outputting the counting values to the detector 716 for judging until the counting value is equal to a preset value in the detector 716 and the detector 716 outputs logic 1. Since the output of the detector 718 is logic 0 and the output of the detector 716 is logic 1 at the point, thus, the third OR gate 720 would output logic 1 (i.e. a control signal) to the switch 610 after a logic operation is performed by the third OR gate 720. Thus, the switch 610 turns off, which furthermore makes the time constant of charging-discharging performed by the resistor 604 and the capacitor 606 incline to infinity, so that the input signal ip-in′ of the comparator 602 remains at a fixed voltage without an exponential decay any more.

When the status of the reset signal RE is logic 0 and the output OP of the comparator 602 is logic 1, a logic operation is performed on the output OP and the reset signal RE by the first OR gate 706, which then outputs logic 1 to make the counter 712 reset the counting value thereof, so as to further make the output of the detector 716 be logic 0. The output OP of the comparator 602 is also sent to the second NOT gate 708 for phase-inverting and then sent to the second OR gate 710 where a logic operation on the output OP and the reset signal RE is performed, and then the second OR gate 710 outputs logic 0 to make the counter 714 continue to count and the counting value is sent to the detector 718 for judging.

If the output status of the comparator 602 is continuous logic 1, the counter 712 would be reset all the time, while the counter 714 would keep counting and keep outputting the counting values to the detector 718 for judging until the counting value is equal to the preset value in the detector 718 and the detector 718 outputs logic 1. Since the output of the detector 716 is logic 0 and the output of the detector 718 is logic 1 at the point, the third OR gate 720 would output logic 1 (i.e. a control signal) to the switch 610 after a logic operation is performed by the third OR gate 720. Thus, the switch 610 turns off, which furthermore makes the time constant of charging-discharging performed by the resistor 604 and the capacitor 606 incline to infinity, so that the input signal ip-in′ of the comparator 602 remains at a fixed voltage without an exponential decay any more.

When the status of the reset signal RE is logic 1, the first OR gate 706 and the second OR gate 710 would output logic 1 to respectively force the counter 712 and the counter 714 to reset the counting value thereof. In the embodiment, the number of the predetermined times in the detectors 716 and 718 can be a common value specified inside or outside.

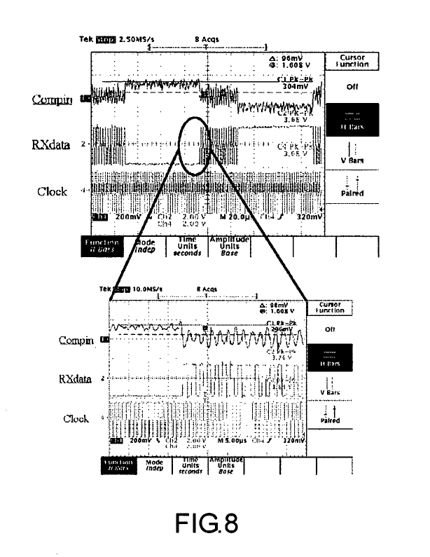

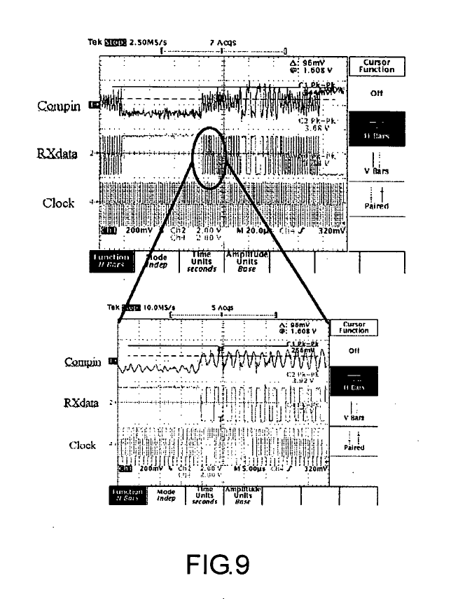

As shown by FIGS. 8 and 9 (wherein, Compin represents a measured signal at the node where the resistor 604 in FIG. 6 is coupled with the modulation signal ip, Rxdata represents a measured output signal from the comparator 602 in FIG. 6 and Clock represents a clock signal), when the number of the continuously present times of the signal in a same logic status outputted from the comparator provided by an embodiment of the present invention reaches a preset value, the counting circuit outputs a control signal to make the resistor at open circuit status and the input ip-in′ of the comparator 602 remains a fixed voltage without an exponential decay any more, so that the slicer circuit is able to continue to judge the input signal correctly.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A slicer circuit, comprising:
a comparator, having a first input terminal, a second input terminal and an output terminal;
a resistor, wherein the first end thereof receives a first modulation signal and is coupled with the first input terminal of the comparator;
a capacitor, wherein the first terminal thereof receives a second modulation signal, while the second terminal thereof is coupled with the second input terminal of the comparator;
a switch, determining whether to cut off the coupling between the second end of the resistor and the second input terminal of the comparator according to a control signal; and
a counting-circuit, counting the output data of the output terminal of the comparator and determining whether to generate the control signal sent to the switch according to the output data of the output terminal.

2. The slicer circuit as recited in claim 1, wherein the first modulation signal and the second modulation signal are differential-mode signals in respect of each other.

3. The slicer circuit as recited in claim 2, wherein when the signal of the first input terminal is larger than the signal of the second input terminal, the output terminal of the comparator outputs an output data in the first logic; when the signal of the second input terminal is larger than the signal of the first input terminal, the output terminal of the comparator outputs an output data in the second logic.

4. The slicer circuit as recited in claim 3, wherein when the output data of the output terminal of the comparator is a signal continuously in a same logic and when the number of the continuous times reaches a preset value, the counting-circuit turns off the switch.

5. The slicer circuit as recited in claim 3, wherein when the continuous two output data of the output terminal of the comparator are signals in different logics, the counting-circuit is reset.

6. The slicer circuit as recited in claim 1, wherein the resistor and the switch are formed by an MOS active device at least, respectively.

7. The slicer circuit as recited in claim 1, wherein the counting-circuit comprises:
a first NOT gate, wherein the input terminal thereof is coupled with the output of the counting-circuit;
a first AND gate, wherein the first input terminal thereof is coupled with the output of the first NOT gate, while the second input terminal thereof receives a clock signal;
a second NOT gate, wherein the input terminal thereof is coupled with the output of the comparator;
a first OR gate, wherein the first input terminal thereof receives a reset signal, while the second input terminal thereof is coupled with the output of the comparator;
a second OR gate, wherein the first input terminal thereof receives the reset signal, while the second input terminal thereof is coupled with the output of the second NOT gate;
a first counter, wherein the input terminal thereof is coupled with the output of the first AND gate, the reset terminal thereof is coupled with the output of the first OR gate, and the first counter generates a first counting value according to the output of the first AND gate;
a second counter, wherein the input terminal thereof is coupled with the output of the first AND gate, the reset terminal thereof is coupled with the output of the second OR gate, and the second counter generates a second counting value according to the output of the first AND gate;
a first detector, receives the first counting value; when the first counting value is larger than a preset value, the first detector outputs a signal in logic 1, otherwise, the detector outputs a signal in logic 0;
a second detector, receives the second counting value; when the second counting value is larger than the preset value, the second detector outputs a signal in logic 1, otherwise, the detector outputs a signal in logic 0; and
a third OR gate, wherein the first input terminal thereof receives the output of the first detector, while the second input terminal receives the output of the second detector.
